(19) United States
(12) Patent Application Publication
(10) Pub. No.: US 2020/0281203 A1
(43) Pub. Date: Sep. 10, 2020

(54) Herbicide Formulations and their Use

(71) Applicant: TANGI-PAC, L.L.C., Ponchatoula, LA (US)

(72) Inventor: Michael Massey, Independence, LA (US)

(73) Assignee: TANGI-PAC, L.L.C., Ponchatoula, LA (US)

(21) Appl. No.: 16/794,870

(22) Filed: Feb. 19, 2020

Related U.S. Application Data
(60) Provisional application No. 62/959,432, filed on Jan. 10, 2020.
(60) Provisional application No. 62/808,459, filed on Feb. 21, 2019.

(51) Int. Cl. A01N 43/60; A01N 57/12; A01N 43/50; A01N 25/30

(52) U.S. Cl. CPC A01N 43/60; A01N 25/30; A01N 43/50; A01N 57/12

(57) ABSTRACT

A composition for use in agriculture includes ammonium glufosinate and diquat dibromide, preferably with a surfactant. It may also advantageously include imazapyr in some circumstances.

### CROSS-REFERENCE TO RELATED APPLICATIONS

This application claims the benefit of U.S. Provisional Patent Application Ser. No. 62/808,459, filed 21 Feb. 2019, and of U.S. Provisional Patent Application Ser. No. 62/959,432, filed 10 Jan. 2020. Priority of U.S. Provisional Patent Application Ser. No. 62/808,459, filed 21 Feb. 2019, and of U.S. Provisional Patent Application Ser. No. 62/959,432, filed 10 Jan. 2020, which are incorporated herein by reference, is hereby claimed.

### STATEMENT REGARDING FEDERALLY SPONSORED RESEARCH OR DEVELOPMENT

Not applicable

### REFERENCE TO A “MICROFICHE APPENDIX” Not applicable

### BACKGROUND OF THE INVENTION

### 1. Field of the Invention

The present invention relates to herbicide formulations, preferably containing glufosinate. More particularly, the present invention relates to herbicide formulations containing glufosinate and increased levels of surfactants.

### 2. General Background of the Invention

In agriculture, herbicides are generally used to kill unwanted weeds. Typically, a surfactant is used in an herbicidal composition to help distribute the herbicide more efficiently by reducing the surface tension of liquid. This keeps the spray on the targeted weed rather than rolling off onto the soil. Without surfactant, herbicidal compositions may form beads and roll off the targeted weed before it is absorbed by the weed making it ineffective. The addition of a surfactant allows the herbicide to evenly coat the surface of the targeted weed allowing for faster absorption, which creates a more effective herbicide in lower concentrations.

This invention is an improvement on my prior inventions listed and described in U.S. Provisional Patent Application Ser. No. 62/808,459, filed on 21 Feb. 2019, which is hereby incorporated herein by reference.

The following publications are incorporated herein by reference: European Patent No. EP0968649; U.S. Pat. Nos. 9,867,376; 8,324,132; and, US Patent Publication No. 2015/0111730.

### BRIEF SUMMARY OF THE INVENTION

The present invention includes an herbicide formulation. Preferably, the formulation includes glufosinate, more preferably it also includes increased amounts of surfactant. Typically, herbicides include 0-15% surfactant; however with glufosinate herbicides, up to 50% surfactant has been found to be most effective and efficient. The novel combination of the present invention provides a more efficient and effective herbicide for agricultural use.

### DETAILED DESCRIPTION OF THE INVENTION

The present invention includes herbicidal formulations.

A preferred composition comprises ammonium glufosinate and diquat dibromide. Preferably, the composition further comprises a surfactant, such as SURFOM® CS 8152 brand surfactant by Oxiteno. Other suitable surfactant blends based on lauryl ether sulfate may also have increased efficacy with glufosinate. In a preferred embodiment, the surfactant is Emulson AG/A4G by Lamberti USA®. Preferably, the surfactant is used at 5-50% concentration. More preferably, the surfactant is used at 15-40% concentration. Most preferably, the surfactant is used at 20% concentration.

Preferably, 98% ammonium glufosinate is used; however, lower concentrations can also be effective. Preferably, 37.3% diquat is used; however, lower concentrations can also be effective.

In the composition for the present invention, the weight ratio of the water-soluble herbicidal ingredients to the adjuvant may range from 1:0.2 to 1:5, optimally 1:1.8 to 1:2.4. However, because this is a mixture of AI's, lower concentrations can also be effective.

Table 1 shows preferred components of preferred herbicide formulas of the present invention:

| | 1 | 2 | 3 |
|---|---|---|---|
| Components | % w/w | % w/w | % w/w |
| Ammonium | 11.3 | 24.5 | 11.3-24.5 |
| Glufosinate (98%) | | | |
| Diquat Dibromide | 0.73 | 1.6 | 0.73-1.6 |
| Surfactant | 20 | 24 | 20-24 |
| Water | Up to 100% | Up to 100% | Up to 100% |

Compositions 1-3 will give much quicker control of grasses and broadleaf weeds than glufosinate alone. The addition of the surfactant formula of the present invention enhances the control because it allows the herbicide to better cover the leaves of the plant. The formula is stable in our formulation because of the surfactant we are using. There is no residual action of this formula in the soil so users can replant the area in a short period of time after spraying it.

Another preferred composition comprises ammonium glufosinate, imazapyr, and diquat dibromide. Preferably, the composition further comprises a surfactant, such as SURFOM® CS 8152 brand surfactant by Oxiteno. Other suitable surfactant blends based on lauryl ether sulfate may also have increased efficacy with glufosinate. In a preferred embodiment, the surfactant is Emulson AG/A4G by Lamberti USA®. Preferably, the surfactant is used at 5-60% concentration. More preferably, the surfactant is used at 15-40% concentration. Most preferably, the surfactant is used at 20% concentration.

Preferably, 98% ammonium glufosinate is used; however, other concentrations can also be effective. Preferably, 27.8% imazapyr is used; however, other concentrations can also be effective. Preferably, 37.3% diquat is used; however, other concentrations can also be effective.

Table 2 shows preferred components of preferred herbicide formulas of the present invention:

| | 4 | 5 | 6 |
|---|---|---|---|
| Components | % w/w | % w/w | % w/w |
| Ammonium | 11.3 | 24.5 | 10-30 |
| Glufosinate (98%) | | | |
| Imazapyr (27.8% | 0.78 | 1.7 | 0.5-1.5 |
| IPA salt) | | | |
| Diquat Dibromide | 0.73 | 1.6 | 0.5-2.0 |
| (37.3%) | | | |
| Surfactant | 24 | 54 | 20-60 |
| Water | Up to 100% | Up to 100% | Up to 100% |

Both compositions 4 and 5 are stable at 54° C. to 4° C. after 2 weeks. Some solids are visible at −10° C., but the sample is completely homogenous after returning to room temperature without agitation.

In tests with SURFOM® CS 8152 brand surfactant by Oxiteno used as the surfactant, good chemical-physical stability was seen after two weeks at all temperatures. Other suitable surfactants may be used.

In a preferred embodiment, a reduced amount of antifoaming agent is recommended to improve foam control. Preferably between 0.1 to 0.2% antifoaming agent is used. Most preferably, formulations from 8% to 45% diquat dibromide can be used.

Preferably, Imazapyr is used in a concentration between 0.5% to 1.5% in order to provide extended control. Preferably, extended control exceeds several months.

Compositions 4-6 will also give much quicker control of grasses and broadleaf weeds than glufosinate alone. The addition of the surfactant formula of the present invention enhances the control because it allows the herbicide to better cover the leaves of the plant. The formula is stable in our formulation because of the surfactant we are using. However, unlike compositions 1-3 in the first table above, compositions 4-6 in the second table above control weeds for up to one year and users cannot plant behind it. These compositions (4-6 in the table above) are total vegetation killers.

The compositions of the present invention are preferably diluted with water before use. Typically, one mixes 2-6 ounces of the composition in 1-10 gallons of water. The diluted product is then typically sprayed on weeds using any suitable method.

In a preferred embodiment, the formulations act quickly and for an extended period of time, preferably several months.

Another preferred composition comprises ammonium glufosinate, and imazapyr. Preferably, the composition further comprises a surfactant, such as SURFOM® CS 8152 brand surfactant by Oxiteno. Other suitable surfactant blends based on lauryl ether sulfate may also have increased efficacy with glufosinate. In a preferred embodiment, the surfactant is Emulson AG/A4G by Lamberti USA®. Preferably, the surfactant is used at 5-60% concentration. More preferably, the surfactant is used at 15-40% concentration. Most preferably, the surfactant is used at 20% concentration.

Preferably, 98% ammonium glufosinate is used; however, other concentrations can also be effective. Preferably, 27.8% imazapyr is used; however, other concentrations can also be effective.

Table 3 shows preferred components of preferred herbicide formulas of the present invention:

| | 7 | 8 | 9 |
|---|---|---|---|
| Components | % w/w | % w/w | % w/w |
| Ammonium | 11.3 | 24.5 | 10-30 |
| Glufosinate (98%) | | | |
| Imazapyr (27.8% | 1.6 | 3.5 | 1.0-7.0 |
| IPA salt) | | | |
| Surfactant | 21 | 22.5 | 20-24 |
| Water | Up to 100% | Up to 100% | Up to 100% |

In a preferred embodiment, the present invention includes the following components in the following concentrations:

TABLE 4

| Components | Alternate | Purpose in | Range % | Preferred % | Preferred |
|---|---|---|---|---|---|
| (preferred) | components | Formulation | weight | weight | amount |
| Glufosinate | RedEagle | Active | 12.25-11.09 | 11.67 | 116.7 |
| Ammonium | International, | ingredient | | | |
| (UPL | LLC | | | | |
| Delaware | | | | | |
| Inc.) | | | | | |
| Imazapyr | Arsenal | Active | 4.16-3.76 | 3.96 | 39.6 |
| (Alligare, | Herbicide | Ingredient | | | |
| LLC) | (BASF | | | | |
| | Corporation) | | | | |
| Blend of | EMULSON | Surfactant | 23.69-22.31 | 23.0 | 230.0 |
| surfactants | AG/A4G | | | | |
| and glycols | (Lamberti | | | | |
| (SURFOM | USA, Inc.) | | | | |
| CS 8152 - | | | | | |
| Oxiteno, | | | | | |
| USA, LLC) | | | | | |
| Water | | Diluent | 63.21-59.53 | 61.37 | 613.7 |
| (Municipal | | | | | |
| Supply) | | | | | |

In a preferred embodiment, the present invention includes the following components in the following concentrations:

TABLE 5

| | Alternate | | | | |
|---|---|---|---|---|---|
| | components | | | | |
| Components | (alternate | Purpose in | Range % | Preferred % | Preferred |
| (preferred source) | source) | Formulation | weight | weight | amount |
| Glufosinate | (RedEagle | Active | 12.25-11.09 | 11.67 | 116.7 |
| Ammonium | International, | Ingredient | | | |
| (UPL Delaware Inc.) | LLC) | | | | |
| Imazapyr | Arsenal | Active | 4.16-3.76 | 3.96 | 39.6 |
| (Alligare, LLC) | Herbicide | Ingredient | | | |
| | (BASF | | | | |
| | Corporation) | | | | |
| 9,10-dihydro-8a,10a- | Verdure-X- | Active | 3.07-2.77 | 2.92 | 29.2 |
| diazoniaphenanthrene | Herbicide - | Ingredient | | | |
| dibromide (Solera | Diquat | | | | |
| Diquat Dibromide - | Dibromide | | | | |
| Source Dynamics | (Helm Agro | | | | |
| LLC) | US, Inc) | | | | |
| Blend of surfactants | EMULSON | Surfactant | 23.69-22.31 | 23.0 | 230.0 |
| and glycols | AG/A4G | | | | |
| (SURFOM CS 8152- | (Lamberti | | | | |
| Oxiteno, USA, LLC) | USA, Inc.) | | | | |
| Water | | Diluent | 60.20-56.70 | 58.45 | 584.5 |
| (Municipal Supply) | | | | | |

All measurements disclosed herein are at standard temperature and pressure, at sea level on Earth, unless indicated otherwise. All materials used or intended to be used in a human being are biocompatible, unless indicated otherwise.

The foregoing embodiments are presented by way of example only; the scope of the present invention is to be limited only by the following claims.

1. A composition for use in agriculture comprising ammonium glufosinate and diquat dibromide.

2. The composition of claim 1 further comprising a surfactant and water.

3. The composition of claim 2 wherein the surfactant comprises SURFOM CS 8152 brand surfactant, or a generic equivalent thereof.

4. The composition of claim 2 wherein the surfactant is 10-60% of the composition.

5-6. (canceled)

7. The composition of claim 1 further comprising imazapyr.

8. The composition of claim 7 further comprising a surfactant and water.

9. The composition of claim 8 wherein the surfactant comprises combinations of generic surfactant ingredients.

10. The composition of claim 9 wherein the surfactant is 10-60% of the composition.

11-12. (canceled)

13. The composition of claim 2 wherein the components are in the concentrations found in Table 1.

14. The composition of claim 8 wherein the components are in the concentrations found in Table 2.

15. A method of using the composition of claim 2 as an herbicide.

16. A method of using the composition of claim 8 as a spray for the treatment of unwanted vegetation.

17. A composition for use in agriculture comprising ammonium glufosinate and imazapyr.

18. The composition of claim 17 further comprising a surfactant and water.

19. The composition of claim 18 wherein the components are in the concentrations found in Table 3.

20. The composition of claim 2 wherein the surfactant comprises Emulson AG/A4G by Lamberti USA® brand surfactant, or a generic equivalent thereof.

21. The composition of claim 20 wherein the surfactant is 10-60% of the composition.

22-23. (canceled)

24. The composition of claim 2 wherein the components are in the concentrations found in Table 4.

25. The composition of claim 8 wherein the components are in the concentrations found in Table 5.

26. (canceled)
